(19) United States
(12) Patent Application Publication
(10) Pub. No.: US 2017/0337584 A1
(43) Pub. Date: Nov. 23, 2017

(54) SYSTEMS AND METHODS FOR SERVING SECONDARY ONLINE CONTENT BASED ON INTERACTIONS WITH PRIMARY ONLINE CONTENT AND CONCIERGE RULES

(71) Applicant: Google Inc., Mountain View, CA (US)

(72) Inventors: William Davison Najdecki, New York, NY (US); Iain Tait, New York, NY (US); Andrew Ackermann, Brooklyn, NY (US); Michael Gerard Morrissey, Atlanta, GA (US); Gabriel Oak Taubman, New York, NY (US); Jason Sanders, New York, NY (US)

(21) Appl. No.: 14/338,574

(22) Filed: Jul. 23, 2014

Related U.S. Application Data
(60) Provisional application No. 61/986,654, filed on Apr. 30, 2014.

(51) Int. Cl. G06Q 30/02

(52) U.S. Cl. CPC G06Q 30/0263; G06Q 30/0257

(57) ABSTRACT

A system and computer-implemented method for providing secondary online content to a user device based on a user interaction with primary online content are provided. The method includes receiving a content request for a primary content item stored in the memory for display on the user device, providing the primary content item for display on the user device, and transmitting a first interaction signal representing a first interaction between the user device and the primary content item, the first interaction signal including a user device identifier and the primary content item identifier. The method further includes accessing at least one concierge rule stored in the memory based on the first interaction signal, retrieving a secondary online content item based at least in part on the at least one concierge rule, and automatically serving the secondary online content item to the user device for display on the user device.

### CROSS REFERENCE TO RELATED APPLICATIONS

This application claims priority to provisional patent application Ser. No. 61/986,654 filed on Apr. 30, 2014, which is hereby incorporated by reference in its entirety.

### BACKGROUND

This specification relates to the interactive online content and, more particularly, to methods and systems for users selecting online content for later review by the user to receive follow-on online content based on information selected by the user, a publisher of online content, a provider of online content, or combinations thereof, that is related to the selected online content.

Some Internet-based publishers and content managers manage online content, such as advertisements, for multiple online content providers (e.g., advertisers). Such a content manager provides content items for display to users in the online environment, and may manage numerous online content items.

Items of online content, for example, are presented to users while the users are engaged in other online activities, such as, but, not limited to using online publications (e.g., web pages, documents, videos, audio files, etc.) and online content items (e.g., advertisements). For example, the user may be reading articles, playing online games, managing personal information, and/or managing email. The presented online content items are generally in the form of a pop-up item, a banner item, a header item, a sidebar item or other form of presentation. If an item of online content catches the attention of the user and the presented online content item pekes the interest of the user, the user will likely click on the online content item to view the online content item. However, in some cases, the user may be too busy performing the other online activities, consequently deciding not to click on the presented online content. In such a case, the user may lose the opportunity to interactive with the online content and the online content provider may lose the opportunity to present further information to the user, which could potentially lead to a sale or other user activity desired by the online content provider.

### BRIEF DESCRIPTION OF THE DISCLOSURE

In one aspect, a computer-implemented method for providing secondary online content to a user device based on a user interaction with primary online content. The method is implemented using a computing device in communication with a memory. The method includes receiving a content request requesting a primary content item stored in the memory for display on the user device, providing the primary content item to the user device for display on the user device in response to the content request, and recording a first interaction signal representing a first interaction between the user device and the primary content item, the first interaction signal including a user device identifier and the primary content item identifier. The method further includes accessing at least one concierge rule stored in the memory based on the first interaction signal, retrieving a secondary online content item based at least in part on the at least one concierge rule, and automatically serving the secondary online content item to the user device for display on the user device.

In another aspect, a computer system is provided. The computer system includes at least one processor and at least one memory comprising computer-executable instructions. When executed by the at least one processor, the computer-executable instructions cause the at least one processor to receive a content request requesting a primary content item stored in the memory for display on the user device, provide the primary content item to the user device for display on the user device in response to the content request, and record a first interaction signal representing a first interaction between the user device and the primary content item, the first interaction signal including a user device identifier and the primary content item identifier. The computer-executable instructions cause the at least one processor to access at least one concierge rule stored in the memory based on the first interaction signal, retrieve a secondary online content item based at least in part on the at least one concierge rule, and automatically serve the secondary online content item to the user device for display on the user device.

In yet another aspect, a computer-readable storage media having computer-executable instructions embodied thereon are provided. When executed by at least one processor, the computer-executable instructions cause the processor to receive a content request requesting a primary content item stored in the memory for display on the user device, provide the primary content item to the user device for display on the user device in response to the content request, and record a first interaction signal representing a first interaction between the user device and the primary content item, the first interaction signal including a user device identifier and the primary content item identifier. The computer-executable instructions also cause the processor to access at least one concierge rule stored in the memory based on the first interaction signal, retrieve a secondary online content item based at least in part on the at least one concierge rule, and automatically serve the secondary online content item to the user device for display on the user device.

In still another aspect, a system for providing secondary online content to a user device based on a user interaction with primary online content is provided. The system includes a means for receiving a content request requesting a primary content item stored in the memory for display on the user device, providing the primary content item to the user device for display on the user device in response to the content request, and recording a first interaction signal representing a first interaction between the user device and the primary content item, the first interaction signal including a user device identifier and the primary content item identifier. The system further includes a means for accessing at least one concierge rule stored in the memory based on the first interaction signal, retrieving a secondary online content item based at least in part on the at least one concierge rule, and automatically serving the secondary online content item to the user device for display on the user device.

In another aspect, the system described above is provided, wherein the system further includes means for recording a first interaction signal including a save command inputted by the user with respect to the primary content item, the save command is configured to save the primary content item to a keeper application. The method further includes a means for recording a second interaction signal representing a second interaction between the user device and the saved primary content item, the second interaction including a purchase of an item associated with the saved primary content item and a means for accessing a second concierge rule of the plurality of concierge rules based on the second interaction.

In yet another aspect, the system described above is provided, wherein the system further includes means for instructing the computing device to create a search query based on the at least concierge rule, means for executing the search query, means for retrieving search results in response to the search query, and means for automatically providing one of the search results to the user device.

In still another aspect, the system described above is provided, wherein the system further includes means for serving the secondary online content item to the user device when the user device is located in a predefined area using a location -based concierge rule.

In yet another aspect, the system describe above is provided, wherein the system further includes means for serving the secondary online content item to the user device when a level of inventory of an item associated with the primary content item reaches a predetermined threshold amount using an inventory-based concierge rule.

In yet another aspect, the system describe above is provided, wherein the system further includes means for parsing the primary content item identifier from the first interaction signal, means for retrieving a plurality of concierge rules stored in the memory based on the primary content item identifier, and a means for automatically serving a plurality of secondary online content items to the user device for display on the user device based on the plurality of concierge rules, at least some of the plurality of secondary online content items being served at different times.

In still another aspect, the system describe above is provided, wherein the system further includes means for embedding the at least one concierge rule in the meta-information of the primary content item and means for linking within the memory the at least one concierge rule to the primary content item.

In still another aspect, the system describe above is provided, wherein the system further includes means for receiving the first interaction signal from the user device after the primary content item is displayed on the user device, the first interaction including a save command inputted by the user with respect to the primary content item, the save command configured to save the primary content item to a keeper application.

### BRIEF DESCRIPTION OF THE DRAWINGS

FIGS. 1-7 show example embodiments of the methods and systems described herein.

FIG. 1 is a schematic block diagram of an example networked environment for displaying publications and online content to a user.

FIG. 2 is a block diagram of a computing device in accordance with an example embodiment of the present disclosure.

FIG. 3 is a data flow diagram of an example networked environment that includes the concierge server shown in FIG. 1 for managing selected online content and providing secondary online content to the user based on that selected online content.

FIG. 4 is a user flow diagram of a secondary online content provider system.

FIG. 5 is a data flow diagram of an item of online content that may be used with the Online Content Management System (OCMS) shown in FIG. 1.

FIG. 6 is a flow diagram of a computer-implemented method for providing secondary online content to a user device based on a user interaction with primary online content.

FIG. 7 is a diagram of components of the concierge server.

Like reference numbers and designations in the various drawings indicate like elements.

### DETAILED DESCRIPTION OF THE DISCLOSURE

Embodiments of the methods and systems described herein enable an online content system to record an interaction signal from a user device representing an interaction between the user device and a primary online content item (e.g., an advertisement), access at least one concierge rule stored in memory based on the interaction signal, and serve a secondary online content item to the user device for display on the user device based on the at least one concierge rule. As used herein, a concierge rule is a rule configured to interpret a user interaction with an item of online content to provide secondary online content to the user that relates to the primary online content. Also, as used herein, secondary online content item refers generally to follow-up advertising content and/or non-advertising information related to a determined entity and delivered to the user.

An online content management system (OCMS) server provides online publications (e.g., web pages, documents, videos, audio files, etc.) and online content items (e.g., advertisements) to user devices. In some cases, the online content items are served to the user device along with the online publications. In other cases, the online content items may be served to the user device in response to a search query.

Online content can be provided to user computer devices, tablets or mobile devices. Online content that is provided to mobile devices have lower click-through rates as compared to other computer devices. One possible reason for the lower click-through rates is that such online content interrupt users, requiring them to stop what they are doing, leave an existing website, and visit a new website. So unless users are really interested in the online content, most users will not click on the online content.

To address this problem, the system described herein includes the OCMS with an assistant component (the “system”). The system also includes a keeper application, which may be stored on the user device or may be stored separately on a separate content server. The assistant component is configured to interact with the keeper application. The keeper application enables a user to save or “keep” online content displayed on their device, which is served to the user device by the OCMS, for future review. For example, if a user is interested in online content displayed on their device, but is not ready to purchase the item included within the online content, the user is able to click on a virtual button included with the online content to save or keep the online content (e.g., the ad) for later viewing without stopping what they are currently doing. The saved online content is saved and managed within the keeper application. The saving of the online content, also referred to herein as the primary online content item, is a user interaction that causes an interaction signal to be sent to the system. The interaction signal is then processed by the assistant component, which is configured to retrieve and send a secondary online content item to the user device based at least in part on concierge rules associated with the primary online content item. The secondary online content item is served to the user via the keeper application.

More specifically, the system is configured to provide secondary online content to a user device based on a user interaction with primary online content. The system is configured to: (a) receive a primary content file including a primary content item, and a primary content item identifier; (b) associate at least one concierge rule with the primary content file; (c) store the primary content file and the associated concierge rule within memory; (d) receive a content request requesting the primary content item for display on the user device; (e) provide the primary content item to the user device for display on the user device in response to the content request; (f) record a first interaction signal representing a first interaction between the user device and the primary content item, the first interaction signal including a user device identifier and the primary content item identifier; (g) access the at least one concierge rule stored in the memory based on the first interaction signal; (h) retrieve a secondary online content item based at least in part on the at least one concierge rule; and (i) automatically serve the secondary online content item to the user device for display on the user device.

In the example embodiment, concierge rules can be embedded in the meta-information of the primary content item, or can be created by the content server and linked within the memory to the primary content item.

In the example embodiment, the primary content item is a first advertisement, and the secondary online content item includes information relating to the first advertisement. For example, the primary content item could be an advertisement for tickets to a professional baseball game, and the secondary online content item could be a weather report for the day of the game.

In the example embodiment, the online content request is received from the user device and requests the first advertisement be served to the user device. It can also be received from the user device as part of a request to serve a publication item along with the first advertisement to the user device.

In the example embodiment, the first interaction signal is received from the user device after the primary content item is displayed on the user device. The first interaction includes a save command inputted by the user with respect to the primary content item. The save command is configured to save the primary content item to a keeper application stored on the user device. The system parses the primary content item identifier from the first interaction signal, retrieves a plurality of concierge rules stored in the memory based on the primary content item identifier, and automatically serves a plurality of secondary online content items to the user device for display on the user device based on the plurality of concierge rules with at least some of the plurality of secondary online content items being served at different times.

In the example embodiment, the concierge rules can be a location-based rule, wherein the secondary online content item is served to the user device when the user device is located in a predefined area. The concierge rule can also be an inventory-based rule, wherein the secondary online content item is served to the user device when a level of inventory of an item associated with the primary content item reaches a predetermine threshold amount.

In the example embodiment, the concierge rule is configured to instruct the system to create a search query based on the at least concierge rule, execute the search query, retrieve search results in response to the search query, and automatically provide one of the search results to the user device.

In the example embodiment, the first interaction signal includes a save command inputted by the user with respect to the primary content item, the save command is configured to save the primary content item to a keeper application. The system is further configured to record a second interaction signal representing a second interaction between the user device and the saved primary content item wherein the second interaction includes a purchase of an item associated with the saved primary content item, and accesses a second concierge rule of the plurality of concierge rules based on the second interaction

The methods and systems described herein may be implemented using computer programming or engineering techniques including computer software, firmware, hardware, or any combination or subset thereof, wherein the technical effects may be achieved by performing at least one of the following steps: (a) receive a primary content file including a primary content item, and a primary content item identifier; (b) associate at least one concierge rule with the primary content file; (c) store the primary content file and the associated concierge rule within memory; (d) receive a content request requesting the primary content item for display on the user device; (e) provide the primary content item to the user device for display on the user device in response to the content request; (f) record a first interaction signal representing a first interaction between the user device and the primary content item, the first interaction signal including a user device identifier and the primary content item identifier; (g) access the at least one concierge rule stored in the memory based on the first interaction signal; (h) retrieve a secondary online content item based at least in part on the at least one concierge rule; and (i) automatically serve the secondary online content item to the user device for display on the user device.

The following detailed description illustrates embodiments of the disclosure by way of example and not by way of limitation. It is contemplated that the disclosure has general application to providing secondary online content to a user based on an online content item selected and saved by the user.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

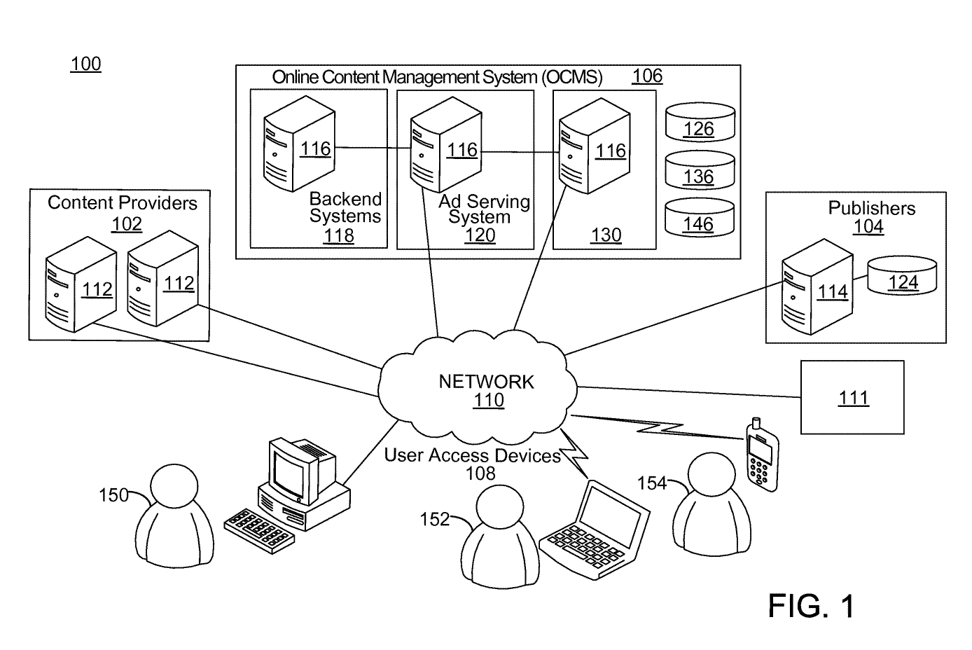

FIG. 1 is a schematic block diagram of an example networked environment 100 for displaying publications and online content to a user. With reference to FIG. 1, an example networked environment 100 may include one or more content providers 102 (alternatively referred to herein as merchants), one or more publishers 104, an online content management system (OCMS) 106, and one or more user access devices 108 (“client computing devices”), which may be coupled to a network 110. User access devices are used by users 150, 152, and 154. Each of the elements 102, 104, 106, 108 and 110 in FIG. 1 may be implemented or associated with hardware components, software components, or firmware components or any combination of such components. The elements 102, 104, 106, 108 and 110 can, for example, be implemented or associated with servers, software processes and engines, and/or various embedded systems. The elements 102, 104, 106 and 110 may serve, for example, as a content serving and concierge network. In the example embodiment, content providers 102 include online advertisers, and OCMS 106 interfaces with a secondary online content providers 111 through network 110 that enables providing concierge-type information to a user that has previously selected online content for later review.

The content providers 102 may include any entities that are associated with content (i.e., a content item or multiple content items). In some embodiments, the content includes any form of communication in which one or more products, services, ideas, messages, people, organizations or other items are identified and promoted (or otherwise communicated). Content is not limited to advertisements and commercial promotions. Rather, content may include public service announcements or any other types of notices, such as public notices published in printed or electronic press or broadcasts.

Content may be communicated via various mediums and in various forms. In some examples, content may be communicated through an interactive medium, such as the Internet, and may include graphical content (e.g., banner content), textual content, image content, audio content, video content, content combining one of more of any of such components, or any form of electronically delivered content. Content may include embedded information, such as embedded media, links, meta-information, and/or machine executable instructions. Content could also be communicated through RSS (Really Simple Syndication) feeds, radio channels, television channels, print media, and other media.

Content can refer to both a single “creative” and a “content group.” A creative refers to any entity that represents one content impression, also referred to herein as an advertisement, or “ad.” A content impression refers to any form of presentation of content such that it is viewable/receivable by a user. In some examples, a content impression may occur when content is displayed on a display device of a user access device (i.e., a “client computing device”). A content group refers, for example, to an entity that represents a group of creatives that share a common characteristic, such as having the same content selection and recommendation criteria. Content groups can be used to create a content campaign.

In some embodiments, one or more ads are affiliated with an “ad group.” An ad group includes one or more ads along with other associated information related to those ads, such as, for example and without limitation, a title, a headline, a budget, targeting criteria, and keywords. In the example embodiment, an ad group includes one ad and associated information. As used herein, the term “ad” and “ad group” may be used interchangeably, as some operations that are performed relative to an ad may also be performed relative to an ad group, and vice versa.

The content providers 102 may provide (or be otherwise associated with) products and/or services related to content. The content providers 102 may include or be associated with, for example, retailers, wholesalers, warehouses, manufacturers, distributors, health care providers, educational establishments, financial establishments, technology providers, energy providers, utility providers, or any other product or service providers or distributors.

The content providers 102 may directly or indirectly generate, maintain, review, and/or analyze content, which may be related to products or services offered by or otherwise associated with the content providers 102. The content providers 102 may include or maintain one or more data processing systems 112, such as servers or embedded systems, coupled to the network 110. The content providers 102 may include or maintain one or more processes that run on one or more data processing systems. In some embodiment, some content providers 102 review online content items using, for example, systems 112 and/or OCMS 106.

The publishers 104 may include any entities that generate, maintain, provide, present and/or otherwise process publications in the environment 100. “Publishers,” in particular, include authors of publications, wherein authors may be individual persons, or, in the case of works made for hire, the proprietor(s) who hired the individual(s) responsible for creating the online publications. The term “publication” refers to various types of web-based, software application-based and/or otherwise presented information, including articles, discussion threads, reports, analyses, financial statements, music, video, graphics, search results, web page listings, information feeds (e.g., RSS feeds), television broadcasts, radio broadcasts, printed information, or any other form of information that may be presented to a user using a computing device such as one of user access devices 108.

In some implementations, the publishers 104 may include publishers with an Internet presence, such as online publication and news providers (e.g., online newspapers, online magazines, television websites, etc.), online service providers (e.g., financial service providers, health service providers, etc.), and the like. The publishers 104 can include software application providers, television broadcasters, radio broadcasters, satellite broadcasters, and other providers of publications. One or more of the publishers 104 may represent a publication network that is associated with OCMS 106.

The publishers 104 may receive requests from the user access devices 108 (or other elements in the environment 100) and provide or present publications to the requesting devices. The publishers may provide or present publications via various mediums and in various forms, including web based and non-web based mediums and forms. The publishers 104 may generate and/or maintain such publications and/or retrieve the publications from other network resources.

In addition to publications, the publishers 104 may be configured to integrate or combine retrieved publications with content that is related or relevant to the retrieved publication for display to users 150, 152, and 154. The relevant content may be provided from OCMS 106 and may be combined with a publication for display to users 150, 152, and 154. In some examples, the publishers 104 may retrieve a publication for display on a particular user access device 108 and then forward the publication to the user access device 108 along with code that causes content from OCMS 106 to be displayed to the user 150, 152, or 154. In other examples, the publishers 104 may retrieve a publication, retrieve relevant content (e.g., from OCMS 106 or the content providers 102), and then integrate the content and the publication to form a page for display to the user 150, 152, or 154. In still other examples, the publishers 104 may provide online content space for sale to advertisers, such as content providers 102. Such content space may be populated with content items from the content providers 102, and may be presented to the user 150, 152, or 154 along with the publications.

As noted above, one or more of the publishers 104 may represent a publication network. In such an implementation, the content providers 102 may be able to present content to users through this publication network. Further, in some embodiments, content providers 102 bid on online content items, for example, through OCMS 106.

The publishers 104 may include or maintain one or more data processing systems 114, such as servers or embedded systems, coupled to the network 110. They may include or maintain one or more processes that run on data processing systems. In some examples, the publishers 104 may include one or more publication repositories 124 for storing publications and other information. Additionally, in some embodiments, publishers 104 and/or content providers 102 may review online content items using, for example, system 114 and/or OCMS 106.

OCMS 106 manages content and provides various services to content providers 102, publishers 104, and user access devices 108. OCMS 106 may store content in a content repository 126 and facilitate the distribution or selective provision and recommendation of content through the environment 100 to the user access devices 108. In the example embodiment, OCMS 106 provides a concierge server 130 that enables management of concierge rules and retrieval of secondary online content items based on the user selected and saved online content item. The concierge rules may be provided by users, such as through a profile that details the type of secondary items the user typically finds useful. The concierge rules may be provided by online content providers 102 and/or content publishers 104. The concierge rules may also be provided by secondary online content providers 111 such as by a subscription or a for-pay service. The concierge rules may be stored with user access device 108, which are then periodically managed by concierge server 130, or the concierge rules may be stored on concierge server 130 and provided to user access device 108 as needed.

OCMS 106 may include one or more data processing systems 116, such as servers or embedded systems, coupled to the network 110. It can also include one or more processes, such as server processes. In some examples, OCMS 106 may include a content serving system 120 and one or more backend processing systems 118. The content serving system 120 may include one or more data processing systems 116 and may perform functionality associated with delivering content to publishers or user access devices 108. The backend processing systems 118 may include one or more data processing systems 116 and may perform functionality associated with identifying relevant content to deliver, processing various rules, performing filtering processes, generating reports, maintaining accounts and usage information, auctioning online content items, and other backend system processing. OCMS 106 can use the backend processing systems 118 and the content serving system 120 to selectively recommend and provide relevant content from the content providers 102 through the publishers 104 to the user access devices 108.

OCMS 106 may include or access one or more crawling, indexing and searching modules (not shown). These modules may browse accessible resources (e.g., the World Wide Web, publisher content, data feeds, etc.) to identify, index and store information. The modules may browse information and create copies of the browsed information for subsequent processing. The modules may also check links, validate code, harvest information, and/or perform other maintenance or other tasks.

Searching modules may search information from various resources, such as the World Wide Web, publications, intranets, newsgroups, databases, and/or directories. The search modules may employ one or more known search or other processes to search data. In some implementations, the search modules may index crawled content and/or content received from data feeds to build one or more search indices. The search indices may be used to facilitate rapid retrieval of information relevant to a search query. Searching modules may also store search results including one or more of search query terms, search results elements, and ads impressions served.

OCMS 106 may include one or more interface or frontend modules for providing the various features to content providers, publishers, and user access devices. For example, OCMS 106 may provide one or more publisher front-end interfaces (PFEs) for allowing publishers to interact with OCMS 106. OCMS 106 may also provide one or more content provider front-end interfaces (CPFEs) for allowing content providers to interact with OCMS 106. In some examples, the front-end interfaces may be configured as web applications that provide users with network access to features available in OCMS 106.

OCMS 106 provides various content management features to the content providers 102. OCMS 106 features may allow users to set up user accounts, set account preferences, create content, select keywords for content, create campaigns or initiatives for multiple products or businesses, view reports associated with accounts, analyze costs and return on investment, selectively identify customers in different regions, selectively recommend and provide content to particular publishers, analyze financial information, analyze content performance, estimate content traffic, access keyword tools, add graphics and animations to content, and review content items as described herein.

OCMS 106 may allow the content providers 102 to create content and input keywords for which the content will appear. In some examples, OCMS 106 may provide content to user access devices or publishers when keywords associated with that content are included in a user request or a requested publication. OCMS 106 may also allow the content providers 102 to set bids for content. A bid may represent the maximum amount a content provider is willing to pay for each content impression, user click-through of content or other interaction with content. A click-through can include any action a user takes to select content. The content providers 102 may also choose a currency and monthly budget.

OCMS 106 may also allow the content providers 102 to view information about content impressions, which may be maintained by OCMS 106. OCMS 106 may be configured to determine and maintain the number of content impressions relative to a particular website or keyword. OCMS 106 may also determine and maintain the number of click-throughs for content as well as the ratio of click-trough's to impressions.

OCMS 106 may also allow the content providers 102 to select and/or create conversion types for content. A “conversion” may occur when a user consummates a transaction related to given content. A conversion could be defined to occur when a user clicks on content, for example a specific content item, is referred to the content provider's web page, and consummates a purchase there before leaving that web page. In another example, a conversion could be defined as the display of content to a user and a corresponding purchase on the content provider's web page within a predetermined time (e.g., seven days). OCMS 106 may store conversion data and other information in a conversion data repository 136.

OCMS 106 may allow the content providers 102 to input description information associated with content. This information could be used to assist the publishers 104 in determining content to publish. The content providers 102 may additionally input a cost/value associated with selected conversion types, such as a five dollar credit to the publishers 104 for each product or service purchased.

OCMS 106 may provide various features to the publishers 104. OCMS 106 may deliver content (associated with the content providers 102) to the user access devices 108 when users access publications from the publishers 104. OCMS 106 can be configured to deliver content that is relevant to publisher sites, publications, and publisher audiences.

In some examples, OCMS 106 may crawl publications provided by the publishers 104 and deliver content that is relevant to publisher sites, publications and publisher audiences based on the crawled publications. OCMS 106 may also selectively recommend and/or provide content based on user information and behavior, such as particular search queries performed on a search engine website. In some examples, OCMS 106 can add search to a publisher site and deliver content configured to provide appropriate and relevant content relative to search results generated by requests from visitors of the publisher site. A combination of these and other approaches can be used to deliver relevant content.

OCMS 106 may allow the publishers 104 to search and select specific products and services as well as associated content to be displayed with publications provided by the publishers 104. For example, the publishers 104 may search through content in the content repository 126 and select certain content for display with their publications.

OCMS 106 may be configured to selectively recommend and provide content created by the content providers 102 to the user access devices 108 directly or through the publishers 104. OCMS 106 may selectively recommend and provide content to a particular publisher 104 (as described in further detail herein) or a requesting user access device 108 when a user requests search results or loads a publication from the publisher 104.

In some implementations, OCMS 106 may manage and process financial transactions among and between elements in the environment 100. For example, OCMS 106 may credit accounts associated with the publishers 104 and debit accounts of the content providers 102. These and other transactions may be based on conversion data, impressions information and/or click-through rates received and maintained by OCMS 106.

“Computing devices”, for example user access devices 108, may include any devices capable of receiving information from the network 110. The user access devices 108 could include general computing components and/or embedded systems optimized with specific components for performing specific tasks. Examples of user access devices include personal computers (e.g., desktop computers), mobile computing devices, cell phones, smart phones, head-mounted computing devices, media players/recorders, music players, game consoles, media centers, media players, electronic tablets, personal digital assistants (PDAs), television systems, audio systems, radio systems, removable storage devices, navigation systems, set top boxes, other electronic devices and the like. The user access devices 108 can also include various other elements, such as processes running on various machines.

The network 110 may include any element or system that facilitates communications among and between various network nodes, such as elements 108, 112, 114 and 116. The network 110 may include one or more telecommunications networks, such as computer networks, telephone or other communications networks, the Internet, etc. The network 110 may include a shared, public, or private data network encompassing a wide area (e.g., WAN) or local area (e.g., LAN). In some implementations, the network 110 may facilitate data exchange by way of packet switching using the Internet Protocol (IP). The network 110 may facilitate wired and/or wireless connectivity and communication.

For purposes of explanation only, certain aspects of this disclosure are described with reference to the discrete elements illustrated in FIG. 1. The number, identity and arrangement of elements in the environment 100 are not limited to what is shown. For example, the environment 100 can include any number of geographically-dispersed content providers 102, publishers 104 and/or user access devices 108, which may be discrete, integrated modules or distributed systems. Similarly, the environment 100 is not limited to a single OCMS 106 and may include any number of integrated or distributed OCMS systems or elements.

Furthermore, additional and/or different elements not shown may be contained in or coupled to the elements shown in FIG. 1, and/or certain illustrated elements may be absent. In some examples, the functions provided by the illustrated elements could be performed by less than the illustrated number of components or even by a single element. The illustrated elements could be implemented as individual processes running on separate machines or a single process running on a single machine.

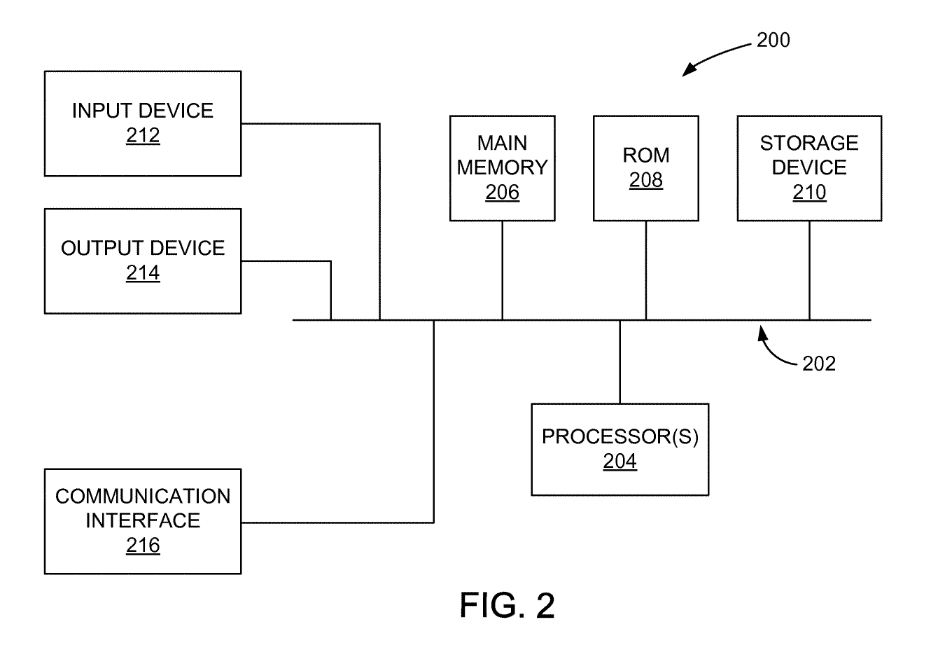

FIG. 2 is a block diagram of a computing device 200. In the example embodiment, computing device is concierge server 130 (shown in FIG. 1), configured to receive a selection of online content selected by a user, store the selected online content for later retrieval by the user, retrieve meta-information associated with secondary online content and based on the selected online content, and to display the secondary online content when requested by the user. FIG. 2 shows an example of a computing device 200 intended to represent various forms of digital computers, such as laptops, desktops, workstations, personal digital assistants, servers, blade servers, mainframes, and other appropriate computers. Computing device 200 is also intended to represent various forms of mobile devices, such as personal digital assistants, cellular telephones, smart phones, and other similar computing devices that could be used for selecting online content items for keeping for later viewing. The components shown here, their connections and relationships, and their functions, are meant to be examples only, and are not meant to limit implementations of the subject matter described and/or claimed in this document.

In various embodiments, computing device 200 represents user access device 108 or any of data processing devices 112, 114, or 116 (shown in FIG. 1). In addition, computing device 200 may represent concierge server 130, wherein it is specifically configured to perform the steps described herein. In the example embodiment where computing device 200 represents concierge server 130, computing device 200 may include a bus 202, a processor 204, a main memory 206, a read only memory (ROM) 208, a storage device 210, an input device 212, an output device 214, and a communication interface 216. Bus 202 may include a path that permits communication among the components of computing device 200.

Processor 204 may include any type of conventional processor, microprocessor, or processing logic that interprets and executes instructions. Processor 204 can process instructions for execution within the computing device 200, including instructions stored in the memory 206 or on the storage device 210 to display graphical information for a GUI on an external input/output device, such as display 214 coupled to a high speed interface. In other implementations, multiple processors and/or multiple buses may be used, as appropriate, along with multiple memories and types of memory. Also, multiple computing devices 200 may be connected, with each device providing portions of the necessary operations (e.g., as a server bank, a group of blade servers, or a multi-processor system). In some embodiments, processor 204 is transformed into a special purpose microprocessor by executing computer-executable instructions or by otherwise being programmed.

Main memory 206 may include a random access memory (RAM) or another type of dynamic storage device that stores information and instructions for execution by processor 204. ROM 208 may include a conventional ROM device or another type of static storage device that stores static information and instructions for use by processor 204. Main memory 206 stores information within the computing device 200. In one implementation, main memory 206 is a volatile memory unit or units. In another implementation, main memory 206 is a non-volatile memory unit or units. Main memory 206 may also be another form of computer-readable medium, such as a magnetic or optical disk.

Storage device 210 may include a magnetic and/or optical recording medium and its corresponding drive. The storage device 210 is capable of providing mass storage for the computing device 200. In one implementation, the storage device 210 may be or contain a computer-readable medium, such as a floppy disk device, a hard disk device, an optical disk device, or a tape device, a flash memory or other similar solid state memory device, or an array of devices, including devices in a storage area network or cloud-based storage or other configurations. A computer program product can be tangibly embodied in an information carrier. The computer program product may also contain instructions that, when executed, perform one or more methods, such as those described above. The information carrier is a computer- or machine-readable medium, such as main memory 206, ROM 208, the storage device 210, or memory on processor 204.

The high speed controller manages bandwidth-intensive operations for the computing device 200, while the low speed controller manages lower bandwidth-intensive operations. Such allocation of functions is for purposes of example only. In one implementation, the high-speed controller is coupled to main memory 206, display 214 (e.g., through a graphics processor or accelerator), and to high-speed expansion ports, which may accept various expansion cards (not shown). In the implementation, low-speed controller is coupled to storage device 210 and low-speed expansion port. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

Input device 212 may include a conventional mechanism that permits computing device 200 to receive commands, instructions, or other inputs from a user 150, 152, or 154, including visual, audio, touch, button presses, stylus taps, etc. Additionally, input device may receive location information. Accordingly, input device 212 may include, for example, a camera, a microphone, one or more buttons, a touch screen, and/or a GPS receiver. Output device 214 may include a conventional mechanism that outputs information to the user, including a display (including a touch screen) and/or a speaker. Communication interface 216 may include any transceiver-like mechanism that enables computing device 200 to communicate with other devices and/or systems. For example, communication interface 216 may include mechanisms for communicating with another device or system via a network, such as network 110 (shown in FIG. 1).

As described herein, computing device 200 facilitates the receive a selection of online content to keep for a user, store the selected online content for later retrieval by the user, retrieve meta-information associated with secondary online content and based on the selected online content, and to display the secondary online content when requested by the user. Computing device 200 may perform these and other operations in response to processor 204 executing software instructions contained in a computer-readable medium, such as memory 206. A computer-readable medium may be defined as a physical or logical memory device and/or carrier wave. The software instructions may be read into memory 206 from another computer-readable medium, such as data storage device 210, or from another device via communication interface 216. The software instructions contained in memory 206 may cause processor 204 to perform processes described herein. Alternatively, hardwired circuitry may be used in place of or in combination with software instructions to implement processes consistent with the subject matter herein. Thus, implementations consistent with the principles of the subject matter disclosed herein are not limited to any specific combination of hardware circuitry and software.

The computing device 200 may be implemented in a number of different forms, as shown in the figure. For example, it may be implemented as a standard server, or multiple times in a group of such servers. It may also be implemented as part of a rack server system. In addition, it may be implemented in a personal computer such as a laptop computer. Each of such devices may contain one or more of computing device 200, and an entire system may be made up of multiple computing devices 200 communicating with each other.

The processor 204 can execute instructions within the computing device 200, including instructions stored in the main memory 206. The processor may be implemented as chips that include separate and multiple analog and digital processors. The processor may provide, for example, for coordination of the other components of the device 200, such as control of user interfaces, applications run by device 200, and wireless communication by device 200.

Computing device 200 includes a processor 204, main memory 206, ROM 208, an input device 212, an output device such as a display 214, a communication interface 216, among other components including, for example, a receiver and a transceiver. The device 200 may also be provided with a storage device 210, such as a microdrive or other device, to provide additional storage. Each of the components is interconnected using various buses, and several of the components may be mounted on a common motherboard or in other manners as appropriate.

Computing device 200 may communicate wirelessly through communication interface 216, which may include digital signal processing circuitry where necessary. Communication interface 216 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver. In addition, short-range communication may occur, such as using a Bluetooth, WiFi, or other such transceiver (not shown). In addition, a GPS (Global Positioning system) receiver module may provide additional navigation- and location-related wireless data to device 200, which may be used as appropriate by applications running on device 200.

Computing device 200 may also communicate audibly using an audio codec, which may receive spoken information from a user and convert it to usable digital information. The audio codec may likewise generate audible sound for a user, such as through a speaker, e.g., in a handset of device. Such sound may include sound from voice telephone calls, may include recorded sound (e.g., voice messages, music files, etc.) and may also include sound generated by applications operating on computing device 200.

Computing device 200 may be implemented in a number of different forms. For example, it may be implemented as a cellular telephone, or as part of a smart phone, personal digital assistant, a computer tablet, or other similar mobile device.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system (e.g., computing device 200) that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In the example embodiment, computing device 200 is concierge server 130 configured to determine an entity of interest associated with online content items selected by the user for later review and to subsequently deliver secondary online content (i.e., non-advertising information) relating to the determine an entity of interest or selected online content items based on meta-information associated with the online content, a user profile containing user preferences, features, historical information, or other information related to such online content items that may be stored within main memory 206, storage device 210, or otherwise received through communications interface 216. In some embodiments, computing device 200 is further configured to correlate information stored in the user profile to the secondary online content that is retrieved and then delivered to the user.

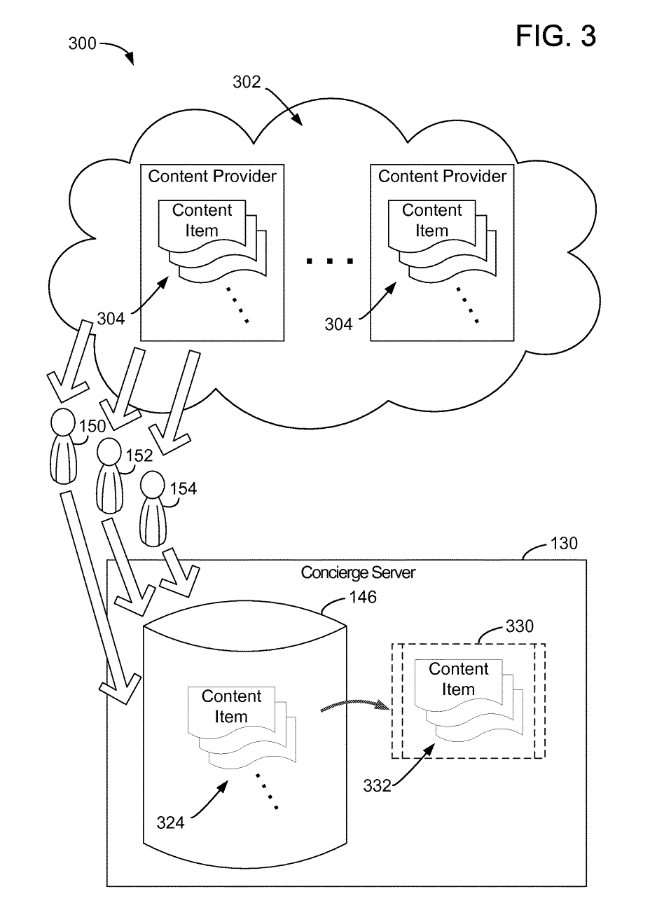

FIG. 3 is a data flow diagram of an example networked environment 300 that includes concierge server 130 for managing selected online content and providing secondary online content to the user based on that selected online content. In some embodiments, networked environment 300 and content providers 302 may be similar to networked environment 100 and content providers 102 as shown in FIG. 1. In the example embodiment, content providers 302 each include one or more content items 304. Content items 304 may include, for example, online advertisements, as well as associated data such as, for example, file-level data or meta-information, advertisement-related data, and/or campaign data that may be intrinsically affiliated with content items 304, or may be additionally defined and provided by content providers 302. As used herein, the term “content item” is used generally to refer to the underlying advertisement together with any additional data that may be associated with the ad.

In the example environment, content providers 302 provide content items 304 to users 150, 152, and/or 154. Additionally, content items 304 may be provided to many more users than just users 150, 152, and/or 154. Users 150, 152, and/or 154 may then interact with content items 304. One way users 150, 152, and/or 154 may interact with content items 304 is to “keep” one or more content items 304 for later viewing. When users 150, 152, and/or 154 “keep” content items 304, content items 304 and associated meta-information is stored, for example, but not limited to, on user access devices 108, or on concierge server 130. Content items 304 may be stored in a database 322 managed by concierge server 130 for later retrieval at the convenience of users 150, 152, and/or 154, or for retrieval by concierge server 130 for applying concierge rules to content items 304. Concierge rules may be applied to content items 304 to generate secondary online content relating to content items 304. Some of the secondary online content may be time sensitive, so that processing the concierge rules prior to a review of content items 304 by users 150, 152, and/or 154 may be appropriate to ensure timely delivery of the secondary online content. For example, if a selected content item 304 is an ad for an event in a city remote from a current location or normal residence of users 150, 152, and/or 154, it may be prudent to provide secondary online content relating to airline tickets to users 150, 152, and/or 154 if the airline tickets have a price or promotion that includes an expiration date. In some embodiments, concierge server 130 may be similar to OCMS 106 (shown in FIG. 1), and database 322 may be similar to database 126, 136, and 146 (shown in FIG. 1). In the example embodiment, content items 324 may include some or all of the associated data provided by content items 304 from content providers 302, and in some embodiments may include additional information associated with content items 324 that may or may not have been provided by content provider 302. For example, content items 324 may include historical usage data or other configuration data not provided by content provider 302.

Further, one or more subsets 330 of content items 332 may be identified within concierge server 130. Subsets 330 include one or more content items 324 from database 322, which may be separate copies of such content items 324 and associated data, or may be logical references to content items 324. For example, content provider 302 provides content items 304 (and associated data) to concierge server 130, which stores the content items 304 along with potentially other data as content items 324 in database 322. Concierge server 130 may also include other content items 324 for other content providers 304, or even other content items 324 from the same content provider. In some embodiments, subset 330 may include all content items 324 from database 322, or all content items 324 that have not yet been retrieved by users 150, 152, and/or 154 for review.

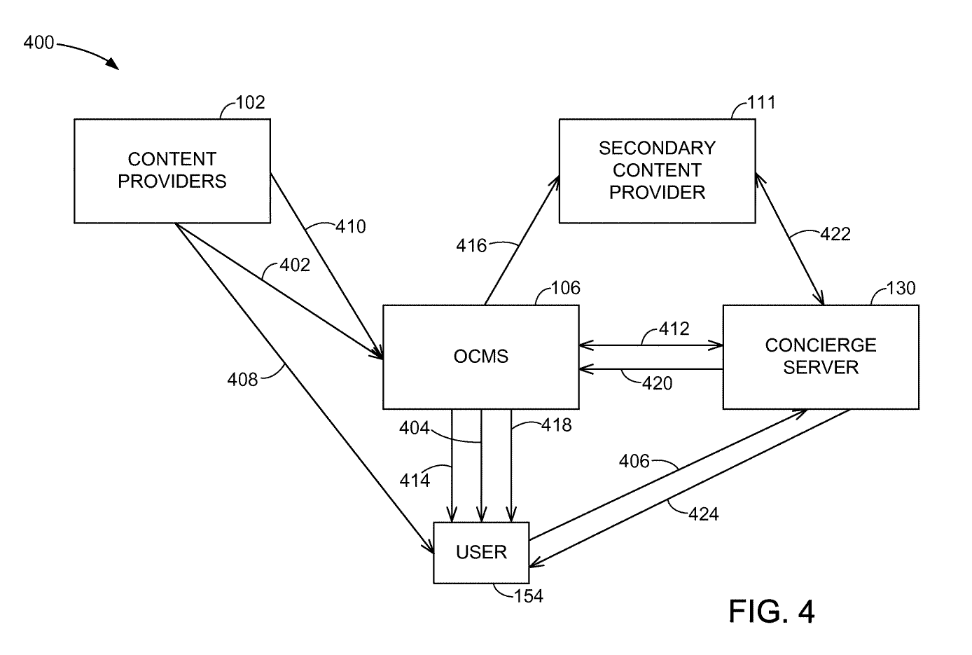

FIG. 4 is a user flow diagram of a secondary online content provider system 400. In the example embodiment, content providers 102 create an ad or online content. The online content is transmitted 402 to OCMS 106 where it may be stored for later retrieval. According to rules stored in OCMS 106 or elsewhere, the online content is pushed 404 to user 154, for example. User 154 can interact with the online content to “keep” it, for example, if the online content interests user 154, but user 154 does not want to review it presently. Information that permits user 154 to retrieve the online content at a later time is transmitted 406 to concierge server 130, in an embodiment. The information may be contained in meta-data associated with the online content or may be an address of a location where the online content is stored.

Additional and/or follow-up information may be transmitted 408 from online content provider 102 to user 154 and/or transmitted 410 from online content provider 102 to OCMS 106. OCMS 106 accesses concierge server 130 to retrieve 412 data of those users 154 that “kept” the online content and serves 414 follow-up information to users 154 that are determined to receive the follow-up information based on concierge rules and/or meta information associated with a respective kept online content item. OCMS 106 can also pull 416 additional information from secondary online content provider 111 and serve 418 the additional information to user 154. When necessary, OCMS can transmit 420 information directly to concierge server 130 to direct concierge server 130 to pull 422 relevant information from secondary online content provider 111 to serve 424 back to user 154.

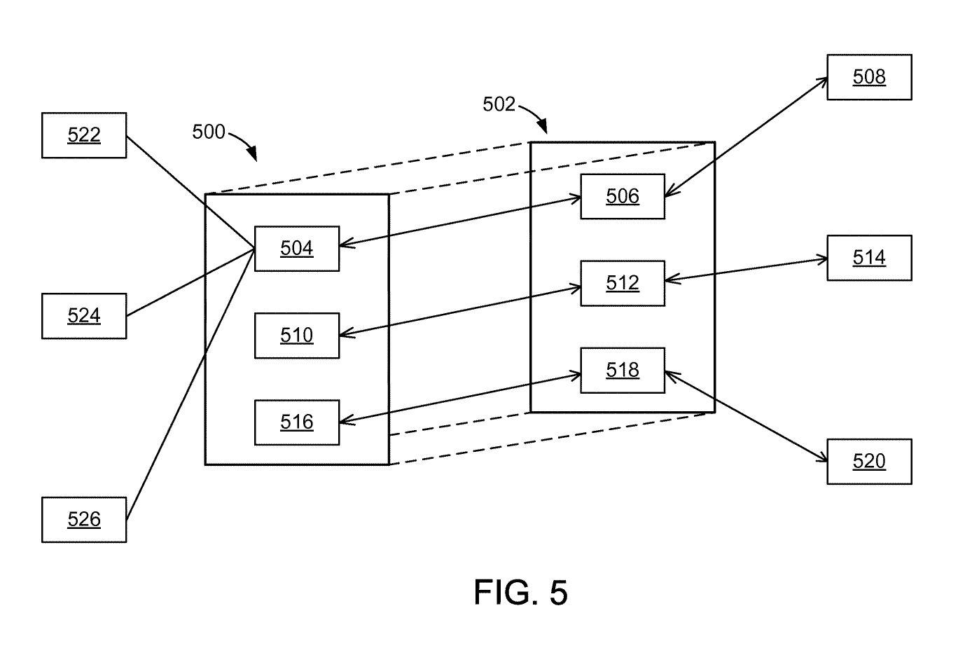

FIG. 5 is a data flow diagram of an item of online content 500 that may be used OCMS 106 (shown in FIG. 1). In the example embodiment, online content item 500 includes meta-information 502 that is generally stored with the associated online content item 500. In various embodiments, meta-information 502 may be stored separately but accessible to processes that access online content item 500. For example, online content item 500 may be stored on user access device 108 while meta-information 502 is transmitted to concierge server 130 for storage there.

Meta-information 502 may include coding for actions to be performed to generate or retrieve secondary online content associated with different functions available to users 150, 152, and/or 154 interacting with online content item 500. For example, online content item 500 may include a first interaction area 504 for saving or “keeping” online content item 500 for later retrieval. First interaction area 504 may be linked to a first meta area 506 that includes coding that implements the saving or keeping of online content item 500. First meta area 506 may then communicate with an external system 508, such as a datastore including a database system. The datastore may be operated by a third-party or a data aggregator for locating information in online content item 500 and determining whether the located information is relevant to any concierge rules.

A second interaction area 510 may be used for sharing online content item 500 through social media, email or other systems. Second interaction area 510 may be linked to a second meta area 512 that includes coding that implements the sharing of online content item 500. Second meta area 512 may then communicate with external systems 514, such as network servers providing access to instant messaging, social media, email or other systems for sharing online content item 500.

A third interaction area 516 may be used for muting online content item. Third interaction area 516 may be linked to a third meta area 518 that includes coding that implements the sharing of online content item 500. Third meta area 518 may then communicate with external systems 520, such as online content servers providing access to block ad campaigns, individual ads, or ads similar to the viewed online content item 500.

When first interaction area 504 is activated by clicking on it, meta data associated with first interaction area 504 captures predetermined aspects of the current online content item 500. Such aspects include, but are not limited to the uniform resource locator (URL) of online content item 500 or other address information for downloading relevant information from online content item 500. Other aspects include an identification of a source of online content item 500 or entity owning online content item 500. Semantic and contextual search algorithms may be employed to discern a subject matter and content of online content item 500. For example, semantic and contextual search algorithms permit an understanding that an online content item 500 concerning the band Black Rebel Motorcycle Club is not related to motorcycle vehicles. The semantic and contextual search algorithms operate in conjunction with the associated meta data, which may provide explicit search instructions for locating secondary online content relating to the online content item online content item 500 selected for keeping.

Secondary online content may relate to activities that may be engaged that supplement or enhance a user's ability to use online content item 500. For example, if online content item 500 relates to a New York Mets baseball game, secondary online content may include a ticketing module 522 that is configured to correlate ticket offers, discounts, special rates, or package deals for the baseball game. Additionally, module 522 monitors the user's interest level, by, for example, tallying a number of times the users returns to the online content item 500 relating to the baseball game. Module 522 also monitors ticket deals in real time so that the user can be contacted, if the user has opted-in to notifications, to make the user aware of the updated ticket pricing or availability.

In the example of the baseball game above, a second module 524 may provide secondary online content relating to travel to and from the baseball game. For example, if the user is local, secondary online content may include traffic information, bus or train routes, estimates of taxi fares, and parking options near the venue. If the user is not local, airline schedule and ticketing information may be included in secondary online content. Module 524 may interface with a GPS system associated with user access device 108 or other geolocation system to determine the user's position in relation to the venue. The determined position can be used to determine whether the user is remote or local to the venue.

A third module 526 may provide secondary online content relating to accommodations proximate the venue. Accommodations may include for example, but not limited to, hotels or restaurants. Again, third module 526 may also use a user's geolocation to ascertain whether hotel information and/or restaurant would be relevant to a user's interest.

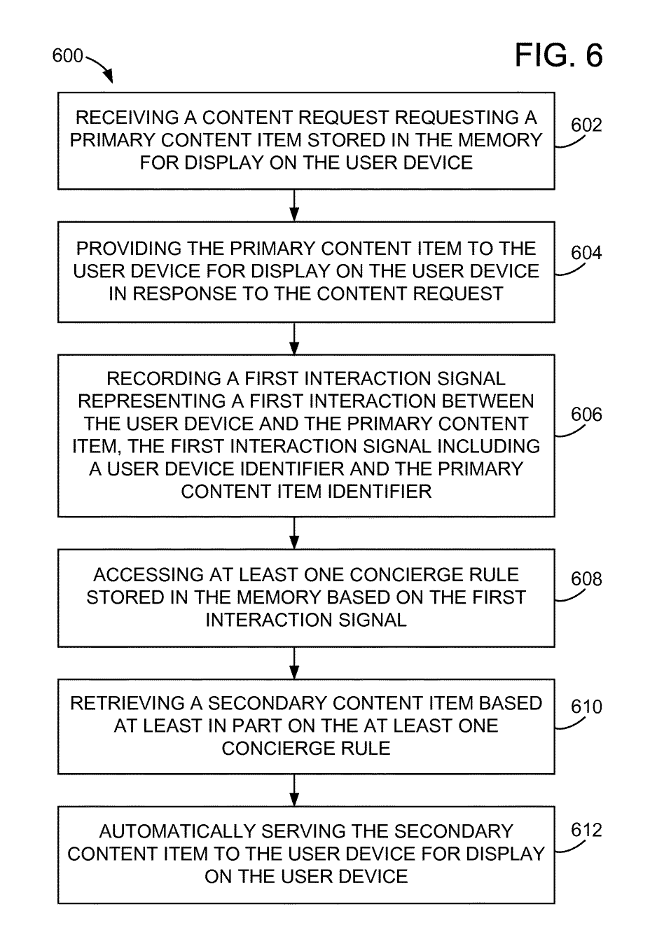

FIG. 6 is a flow diagram of a computer-implemented method 600 for providing secondary online content to a user device based on a user interaction with primary online content. Method 600 is implemented using a computing device in communication with a memory. In the example embodiment, method 600 includes receiving 602 a content request requesting a primary content item stored in the memory for display on the user device and providing 604 the primary content item to the user device for display on the user device in response to the content request. Method 600 also includes transmitting 606 a first interaction signal representing a first interaction between the user device and the primary content item wherein the first interaction signal includes a user device identifier and the primary content item identifier and accessing 608 at least one concierge rule stored in the memory based on the first interaction signal. Method 600 further includes retrieving 610 a secondary online content item based at least in part on the at least one concierge rule and automatically serving 612 the secondary online content item to the user device for display on the user device.

Method 600 optionally includes receiving a primary content file including a primary content item, and a primary content item identifier. The primary content file is generally received from a publisher or online content provider. Method 600 also includes associating at least one concierge rule with the primary content file and storing the primary content file and the associated concierge rule within the memory. The concierge rule may be associated by the publisher and/or provider, before or after the primary content file is received.

When associating the at least one concierge rule with the primary content file, method 600 further includes at least one of embedding the at least one concierge rule in the meta-information of the primary content item and linking within the memory the at least one concierge rule to the primary content item. In various embodiments, the primary content item is a first advertisement and the secondary online content item is information relating to the first advertisement.

Additionally, receiving a content request further includes at least one of receiving a request from the user device to serve a first advertisement to the user device and receiving a request from the user device to serve a publication item along with a first advertisement to the user device. Further, recording a first interaction signal also includes receiving the first interaction signal from the user device after the primary content item is displayed on the user device, the first interaction including a save command inputted by the user with respect to the primary content item, the save command configured to save the primary content item to a keeper application, parsing the primary content item identifier from the first interaction signal, retrieving a plurality of concierge rules stored in the memory based on the primary content item identifier, and automatically serving a plurality of secondary online content items to the user device for display on the user device based on the plurality of concierge rules, at least some of the plurality of secondary online content items being served at different times. Additionally or alternatively, method 600 may include recording a second interaction signal representing a second interaction between the user device and the saved primary content item, the second interaction including a purchase of an item associated with the saved primary content item, and accessing a second concierge rule of the plurality of concierge rules based on the second interaction.

In the example embodiment, the at least one concierge rule further includes a location-based rule, wherein the secondary online content item is served to the user device when the user device is located in a predefined geographical area. Moreover, in other embodiments, the at least one concierge rule further includes an inventory-based rule, wherein the secondary online content item is served to the user device when a level of inventory of an item associated with the primary content item reaches a predetermine threshold amount. The at least one concierge rule is configured to instruct the computing device to create a search query based on the at least concierge rule, execute the search query, retrieve search results in response to the search query, and automatically provide one of the search results to the user device.

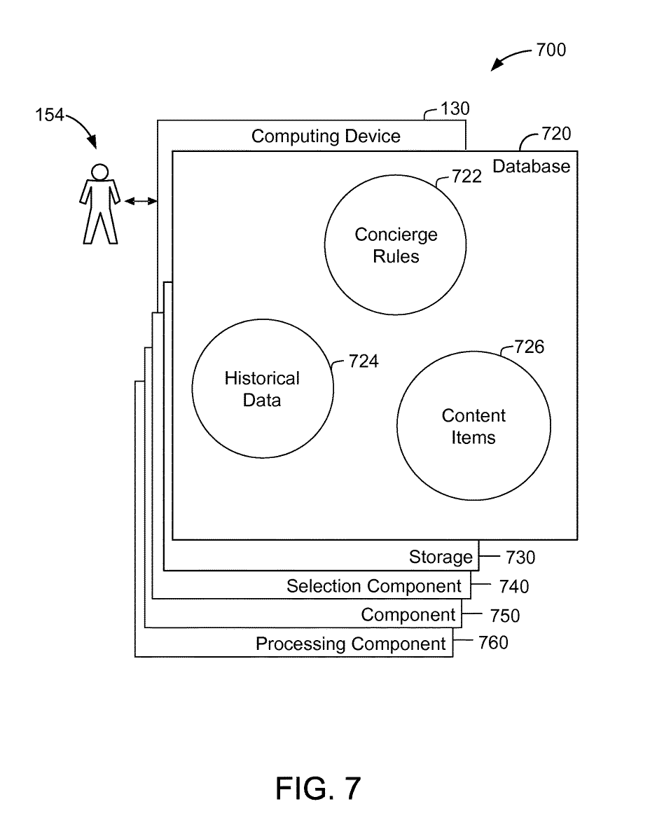

FIG. 7 is a diagram 700 of components of concierge server 130. In the example embodiment, concierge server 130 uses one or more computing devices, for example servers 116 (shown in FIG. 1) and/or computing device 200 (shown in FIG. 2). FIG. 7 further shows a configuration of a database 720 which is coupled to several separate components within concierge server 130, which perform specific tasks.

In an example embodiment, database 720 is divided into a plurality of sections, including but not limited to, a concierge rules section 722, a historical data section 724, and a content items section 726. These sections within database 720 are interconnected to retrieve information pertaining to the operations and components described herein. In some embodiments, database 720 is similar to databases 126, 136, and 146 (shown in FIG. 1).

Concierge server 130 further includes a storage component 730 for storing information associated with database 720. Concierge server 130 also includes a selection component 740 for analyzing content items 726 and other associated data, and selecting content items for display to the user as secondary online content. Concierge server 130 additionally includes a locator component 750 for computing scores and other values associated with content items. Concierge server 130 additionally includes a processing component 760 for performing other operations associated with selecting content items for determining secondary online content.

It will be appreciated that the above embodiments that have been described in particular detail are merely example or possible embodiments, and that there are many other combinations, additions, or alternatives that may be included.

Also, the particular naming of the components, capitalization of terms, the attributes, data structures, or any other programming or structural aspect is not mandatory or significant, and the mechanisms that implement the embodiments or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or “providing” “retrieving” “receiving” or the like, refer to the action and processes of a computer system, or similar electronic computing device, that manipulates and transforms data represented as physical (electronic) quantities within the computer system memories or registers or other such information storage, transmission or display devices.

Based on the foregoing specification, the above-discussed embodiments of the disclosure may be implemented using computer programming or engineering techniques including computer software, firmware, hardware or any combination or subset thereof Any such resulting program, having computer-readable and/or computer-executable instructions, may be embodied or provided within one or more computer-readable media, thereby making a computer program product, i.e., an article of manufacture, according to the discussed embodiments of the disclosure. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

While the disclosure has been described in terms of various specific embodiments, it will be recognized that the disclosure can be practiced with modification within the spirit and scope of the claims.

1. A computer-implemented method for providing secondary online content received from a content provider through a content server to a user device based on a user interaction with primary online content received from the content provider through the content server to the user device, said method implemented using a computing device in communication with a memory, said method comprising:
receiving a content request requesting a primary content item stored in the memory for display on the user device;
providing, by the content server, the primary content item to the user device for display on the user device in response to the content request;
receiving a first interaction signal, from the user device, the first interaction signal generated by the user device in response to a first interaction between the user device and the primary content item, the first interaction signal including a primary content item identifier that identifies the primary content item, the first interaction signal including an opt-in permission for the content provider to provide a secondary online content item received from the content provider to the user device;
parsing the first interaction signal to determine the primary content item identifier;
storing, the primary content item identifier to a keeper application;
retrieving at least one concierge rule stored in the memory based on the primary content item identifier, the at least one concierge rule comprising a location-based rule and instructions for selecting content based on the primary online content;
triggering the at least one concierge rule responsive to receiving an indication the user device is within a predefined area;
selecting, responsive to triggering the at least one concierge rule and using the instructions for selecting content, a secondary online content item from the content provider; and
automatically serving the secondary online content item to the user device for display on the user device.

2. The method in accordance with claim 1, further comprising:
receiving a primary content file including a primary content item, and a primary content item identifier;
associating the at least one concierge rule with the primary content file; and
storing the primary content file and the associated concierge rule within the memory.

3. The method in accordance with claim 2, wherein associating at least one concierge rule with the primary content file further comprises at least one of:
embedding the at least one concierge rule in meta-information of the primary content item; and
linking within the memory the at least one concierge rule to the primary content item.

4. The method in accordance with claim 1, wherein the primary content item is a first advertisement, and the secondary online content item is information relating to the first advertisement.

5. The method in accordance with claim 1, wherein receiving a content request further comprises at least one of:
receiving a request from the user device to serve a first advertisement to the user device; and
receiving a request from the user device to serve a publication item along with a first advertisement to the user device.

6. The method in accordance with claim 1, wherein transmitting a first interaction signal further comprises:
receiving the first interaction signal from the user device after the primary content item is displayed on the user device, the first interaction including a save command inputted by the user with respect to the primary content item, the save command configured to save the primary content item to a keeper application stored on the user device;
parsing the primary content item identifier from the first interaction signal;
retrieving a plurality of concierge rules stored in the memory based on the primary content item identifier; and
automatically serving a plurality of secondary online content items to the user device for display on the user device based on the plurality of concierge rules, at least some of the plurality of secondary online content items being served at different times.

7. (canceled)

8. The method in accordance with claim 1, wherein the at least one concierge rule further comprises an inventory-based rule, wherein the secondary online content item is served to the user device when a level of inventory of an item associated with the primary content item reaches a predetermine threshold amount.

9. The method in accordance with claim 1, wherein the at least one concierge rule further comprises:
instructing the computing device to create a search query based on the at least concierge rule;
executing the search query;
retrieving search results in response to the search query; and
automatically providing one of the search results to the user device.

10. The method in accordance with claim 1, further comprising:
transmitting the first interaction signal including a save command inputted by the user with respect to the primary content item to the keeper application, the save command configured to save the primary content item to the keeper application;
transmitting a second interaction signal transmit a second interaction signal to the keeper application, the second interaction signal representing a second interaction between the user device and the saved primary content item, the second interaction including a purchase of an item associated with the saved primary content item; and
accessing a second concierge rule of the plurality of concierge rules based on the second interaction.

11. A computer system comprising:
at least one processor; and
at least one memory comprising computer-executable instructions that, when executed by said at least one processor, cause said at least one processor to:
receive a content request requesting a primary content item stored in the memory for display on a user device;
provide the primary content item to the user device for display on the user device in response to the content request;
receive a first interaction signal, from the user device, the first interaction signal generated by the user device in response to a first interaction between the user device and the primary content item, the first interaction signal including a primary content item identifier that identifies the primary content item, the first interaction signal including an opt-in permission for a content provider of the primary content item to provide a secondary online content item received from the content provider to the user device;
parse the first interaction signal to determine the primary content item identifier;
store, the primary content item identifier to a keeper application;
receive at least one concierge rule stored in the memory based on the primary content item identifier, the at least one concierge rule comprising a location-based rule and instructions for selecting content based on the primary online content;
trigger the at least one concierge rule responsive to receiving an indication the user device is within a predefined area;
select, responsive to triggering the at least one concierge rule and using the instructions for selecting content, a secondary online content item from the content provider; and
automatically serve the secondary online content item to the user device for display on the user device.

12. The computer system of claim 11, wherein said computer-executable instructions further cause said at least one processor to:
receive a primary content file including a primary content item, and a primary content item identifier;
associate the at least one concierge rule with the primary content file; and
store the primary content file and the associated concierge rule within the memory.

13. The computer system of claim 11, wherein said computer-executable instructions further cause said at least one processor to:
embed the at least one concierge rule in meta-information of the primary content item; and
link within the memory the at least one concierge rule to the primary content item.

14. The computer system of claim 11, wherein said computer-executable instructions further cause said at least one processor to:
receive a request from the user device to serve a first advertisement to the user device; and
receive a request from the user device to serve a publication item along with a first advertisement to the user device.

15. The computer system of claim 11, wherein said computer-executable instructions further cause said at least one processor to:
receive the first interaction signal from the user device after the primary content item is displayed on the user device, the first interaction including a save command inputted by the user with respect to the primary content item, the save command configured to save the primary content item to a keeper application stored on the user device;
parse the primary content item identifier from the first interaction signal;
retrieve a plurality of concierge rules stored in the memory based on the primary content item identifier; and
automatically serve a plurality of secondary online content items to the user device for display on the user device based on the plurality of concierge rules, at least some of the plurality of secondary online content items being served at different times.

16. A non-transitory computer readable storage media having computer-executable instructions embodied thereon, wherein, when executed by at least one processor, the computer-executable instructions cause the processor to:
receive a content request requesting a primary content item stored in the memory for display on a user device;
provide the primary content item to the user device for display on the user device in response to the content request;
receive a first interaction signal, from the user device, the first interaction signal generated by the user device in response to a first interaction between the user device and the primary content item, the first interaction signal including a primary content item identifier that identifies the primary content item, the first interaction signal including an opt-in permission for a content provider of the primary content item to provide a secondary online content item received from the content provider to the user device;
parse the first interaction signal to determine the primary content item identifier;
store, the primary content item identifier to a keeper application;
receive at least one concierge rule stored in the memory based on the primary content item identifier, the at least one concierge rule comprising a location-based rule and instructions for selecting content based on the primary online content;
trigger the at least one concierge rule responsive to receiving an indication the user device is within a predefined area;
select, responsive to triggering the at least one concierge rule and using the instructions for selecting content, a secondary online content item from the content provider; and
automatically serve the secondary online content item to the user device for display on the user device.

17. (canceled)

18. The computer-readable storage media of claim 16, wherein the computer-executable instructions further cause the processor to:
serve the secondary online content item to the user device when a level of inventory of an item associated with the primary content item reaches a predetermined threshold amount using an inventory-based concierge rule.

19. The computer-readable storage media of claim 16, wherein the computer-executable instructions further cause the processor to:
instruct a computing device to create a search query based on the at least concierge rule;
execute the search query;
retrieve search results in response to the search query; and
automatically provide one of the search results to the user device.

20. The computer-readable storage media of claim 16, wherein the computer-executable instructions further cause the processor to:
record a first interaction signal, the first interaction including a save command inputted by the user with respect to the primary content item, the save command configured to save the primary content item to a keeper application, and wherein the computer-executable instructions further cause the processor to:
record a second interaction signal representing a second interaction between the user device and the saved primary content item, the second interaction including a purchase of an item associated with the saved primary content item; and
access a second concierge rule of the plurality of concierge rules based on the second interaction.
